(19) United States
(12) Patent Application Publication
(10) Pub. No.: US 2010/0013137 A1
(43) Pub. Date: Jan. 21, 2010

(54) Clamping Device

(75) Inventor: Hans-Michael Weller, Affalterbach (DE)

Correspondence Address: AKERMAN SENTERFITT, P.O. BOX 3188, WEST PALM BEACH, FL, 33402-3188, US

(73) Assignee: Hainbuch GmbH Spannende Technik, Marbach (DE)

(21) Appl. No.: 12/304,235

(22) PCT Filed: May 31, 2007
(86) PCT No.: PCT/EP2007/004806

§ 371 Date: Feb. 9, 2009

(30) Foreign Application Priority Data
Jun. 12, 2006 (EP) 10 2006 028 060.1

(51) Int. Cl. B25B 1/06; B25B 1/14; B25B 1/10

(52) U.S. Cl. 269/218; 269/228; 269/240

(57) ABSTRACT

A vice (11) has two clamping jaws (15) for clamping workpieces. Between the clamping jaws (15), there is a tensioning device (18) for multi-part chuck heads that operates in a downward direction. Both the clamping jaws (15) and the tensioning device (18) are simultaneously activated by means of a single activation device (21, 30, 31, 37), wherein the activation device has two levers (21). On the one hand, these levers are pressed apart at one end, while on the other hand, they have a projection (24) that engages with a coupling pipe (25) for synchronized movement. The coupling pipe (25) is used to activate the tensioning device (18).

### FIELD OF APPLICATION AND PRIOR ART

The invention relates to a clamping mechanism in the nature of a vice, two clamping jaws being guided with a guide on a structure and can be moved towards one another for clamping a workpiece. Such clamping mechanisms are known to the expert in numerous different forms. However, they are usually only suitable for clamping flat workpieces or workpieces having plane-parallel sides. Special clamping jaws must be used for non-prismatic workpieces, such as e.g. pipes.

### PROBLEM AND SOLUTION

The problem of the invention is to create an aforementioned clamping mechanism having an extended functionality, preferably for clamping hitherto difficultly handlable workpieces, such as in particular those of a non-prismatic nature.

This problem is solved by a clamping mechanism having the features of claim 1. Advantageous and preferred developments of the invention form the subject matter of the further claims and are explained in greater detail hereinafter. By express reference the wording of the claims is made into part of the content of the description.

According to the invention, on the structure and in addition to the clamping jaws is provided a clamping means for clamping heads or collets, said clamping means having an axial actuating direction into the structure. Obviously the actuating direction of the clamping means can be precisely the opposite, i.e. precisely out of said structure. The advantage of such an additional clamping means is that the structure can be used several times. This in particular makes it possible to fit the clamping mechanism or vice to a machine tool, e.g. a drilling machine. As a function of the workpiece to be clamped, the clamping function with the clamping jaws can be used or use can be made of a clamping head similar to DE 101 38 330 A1 or a collet similar to DE 203 20 084 U1, particularly if pipes or similar round stock is to undergo machining. Thus, there is no need to replace the complete vice or complete clamping mechanism. This represents a major advantage with an increase in the machining speed and a facilitation of work.

Advantageously in the case of such a clamping mechanism the clamping jaws are in each case uniformly moved from both sides to a point located between them. This is in particular a movement towards the clamping means and for this purpose said means can be placed between the clamping jaws. The access or attachment direction of a workpiece to be clamped at the clamping means can be the same as at the clamping jaws.

In an advantageous development of the invention a single actuating device is provided with which the clamping jaws can be moved or with which the clamping process can be carried out. Thus, the clamping mechanism can be easily and rapidly operated. The actuating device can be manually actuated, e.g. as a screw spindle, lever, etc. It can also be hydraulically or pneumatically actuated, but this plays no part within the scope of the invention.

In a particularly advantageous development of the invention, the clamping jaws and the further clamping means on the structure have the same drive or same control. This is in particular the aforementioned single actuating device. More specifically said drive or said actuating device is constructed in such a way that both the clamping jaws and also the further clamping means can be simultaneously actuated, independently of which of the two is to be used. It is possible for the clamping jaws to be removed from the structure or, as is generally standard practice for such vices, to run on a carriage in a guide and to be fixed to said carriage in different positions for different clamping widths. The advantage of such a single actuating device is that there is a considerable reduction of costs for the mechanical construction of the clamping mechanism and as a result actuation is very simple.

The said actuating device can have a lever gear with actuating mechanisms, particularly levers, for the clamping jaws and the clamping means. Such a lever gear allows a very good and efficient force transmission. An individual actuating mechanism can be provided for each clamping jaw. These actuating mechanisms are in turn connected to one another or forcibly coupled for a simultaneous movement. Advantageously said forced coupling takes place by means of a coupling part. This so-tospeak ensures the mechanical synchronization of the lever movement, which ensures a uniform clamping, particularly if the two clamping jaws are in each case moved simultaneously to a point between them.

In a further advantageous development of the invention said coupling part can additionally be part of the clamping means. Thus, it can perform a double function. In particular, it can activate or actuate the clamping means. For this purpose it can be a type of vent pipe for a multipart clamping head of the aforementioned type, which cooperates with the clamping means or can be inserted in the latter for clamping workpieces. In this way the aforementioned idea can be implemented, that overall a single actuating device can be provided for the entire clamping mechanism, i.e. both for the clamping jaws and for the clamping means.

The actuating device can advantageously be constructed in such a way that the coupling part is moved downwards into the structure on moving the clamping jaws towards one another. This is at the same time the clamping direction of the clamping means, e.g. a drawing in and compressing clamping of a clamping head in the clamping means.

The two actuating mechanisms of the clamping jaws can engage externally on the coupling part, namely on opposite sides. This is particularly advantageous for a tube or pipe-like coupling part. For this purpose the actuating mechanisms can have a projection or the like, which engages in corresponding recesses or grooves on the outside of the coupling part. This application or engagement is of a positive nature along the movement direction of the coupling part and consequently in particular in both directions. Thus, a movement of the actuating mechanisms and the coupling part is always precisely predetermined.

The actuating mechanisms can have or be constructed as lever arms. At one end the lever arms can be connected to the actuating device, in particular by means of interposed parts such as levers or linkages. At a first, other end they are in each case connected to a clamping jaw or a guide block for a clamping jaw. At a second, other end they are connected to the clamping means or an aforementioned coupling part of said clamping means, particularly in the aforementioned manner by positive engagement. A pivot or support point of said lever arms is advantageously located between the connection to the actuating device on the one hand and the connection to the clamping jaws on the other and e.g. this leads to a 1:1 power ratio, which ensures a good ratio between the force or power to be expended and the simultaneously covered clamping path.

The clamping device can have a thrust linkage by means of which the actuating device actuates both actuating mechanisms. For this purpose the actuating device is connected to the thrust linkage. Such a connection can e.g. be constructed in such a way that a screw or a threaded rod is fixed or non-rotatably mounted on the closest actuating mechanism. This screw engages in a rotary nut, which is mounted on the thrust linkage and can be turned from the outside, e.g. by means of a lever or tool. On turning the nut from the outside, i.e. on actuating the clamping mechanism, the nut and screw are tightened and by means of the thrust linkage the actuating mechanisms are moved towards one another, particularly in the area where they are connected by means of nut and screw.

The aforementioned thrust linkage runs in a plane within the structure through which passes the clamping means or which traverses said clamping means. The thrust linkage advantageously has a large, free middle area and runs bilaterally close to the outer edge of the structure, i.e. round the clamping means. This can be brought about in that the thrust linkage has two outer thrust rods which are interconnected by means of a relatively wide connection spindle. One of the actuating mechanisms is mounted on one connection spindle and the aforementioned nut on the other connection spindle. This leads to a very compact clamping mechanism construction and the actuation of the actuating mechanism, which is remote from the actuation side, takes place through the clamping means or the region of the clamping means and passes round said clamping means.

These and further features can be gathered from the claims, description and drawings and the individual features, both singly and in the form of subcombinations, can be implemented in an embodiment of the invention and in other fields and can represent advantageous, independently protectable constructions for which protection is claimed here. The subdivision of the application by means of subheadings and the individual sections in no way restrict the general validity of the statements made thereunder.

### BRIEF DESCRIPTION OF THE DRAWINGS

An embodiment of the invention is described hereinafter relative to the drawings, wherein show:

FIG. 1 An oblique view of an inventive vice as a clamping mechanism.

FIG. 2 A lateral section through the vice of FIG. 1 to illustrate the lever arms for actuation.

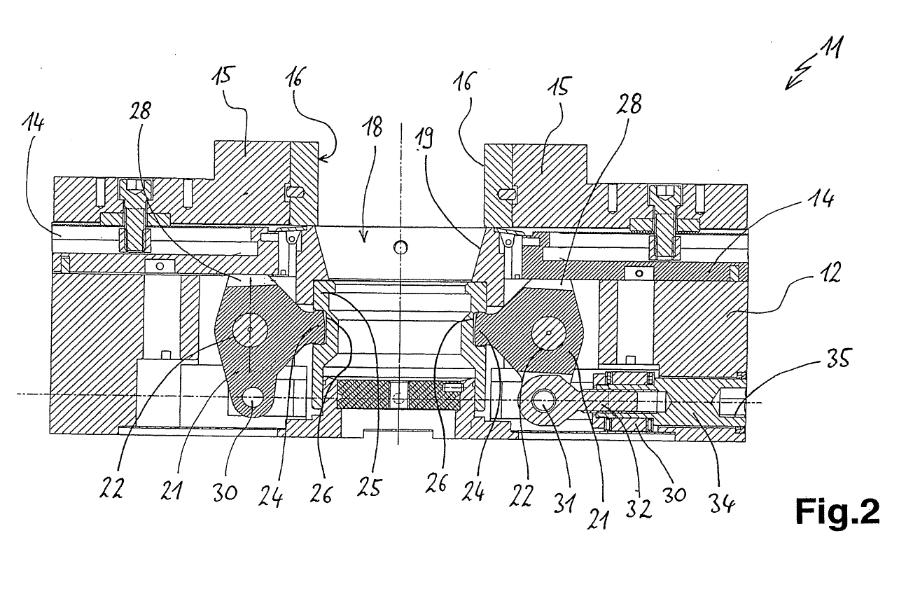

FIG. 3 A section through the vice of FIG. 1 in plan view to illustrate the thrust linkage past the central, additional clamping means.

### DETAILED DESCRIPTION OF THE EMBODIMENT

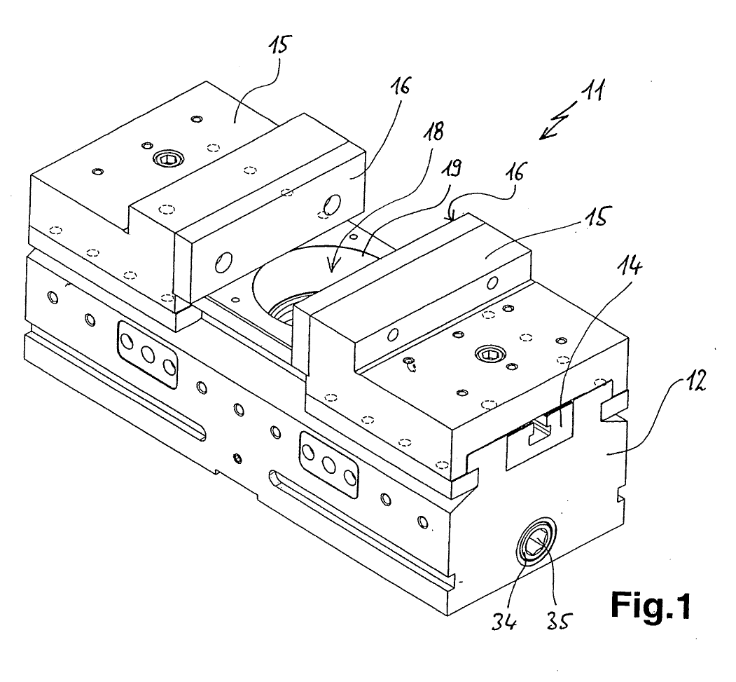

FIG. 1 is an oblique view of the vice 11 with an externally fundamentally known construction. In the upper area and on each side a clamping carriage 14, particularly with a not shown milled top side, runs on a structure 12. On each of said clamping carriages 14 is screwed a clamping jaw 15, said screwing being such that the clamping jaws 15 can be fixed at a random point on said clamping carriages 14 in order to adjust the width between the clamping faces 16 to adapt to the workpieces to be clamped, as is generally known to the expert.

It is clear that roughly in the centre of the top side of the structure 12, i.e. between the clamping jaws 15, an additional clamping means 18 is provided. It has an inside taper 19 for the use of clamping heads or clamping bushes, such as are e.g. referred to hereinbefore and consequently no further details are required here. The precise actuation of the additional clamping means like that of the clamping jaws will be described in greater detail hereinafter.

In the interior of structure 12 are provided two lever arms 21, which are mounted to rotate about lever arm spindles 22. The lever arms 21 are constructed substantially homologously to a vertical middle plane of vice 11 shown in dot-dash line form. The lever arms 21 run essentially vertically and in each case roughly level with the lever arm spindles 22 a projection 24 extends towards the middle plane and three sides thereof are slightly rounded in order to engage better in grooves 26 in a coupling pipe 25 located between them. Said coupling pipe 25 is positioned precisely below the additional clamping means 18 or the inside taper 19. It serves more particularly to draw downwards the aforementioned clamping heads or bushes into the additional clamping means for the actuation thereof or for performing the clamping process. The coupling pipe 25 is mounted both in its upper area in a corresponding extension of the inside taper 19 and in its lower area in such a way that it is always precisely vertically guided or movable.

In the upwards direction the lever arms 21 engage with further projections 28 in a not shown manner in clamping jaws 15. This engagement can take place in much the same way as with the projections 24 in grooves 26, corresponding recesses being provided in the clamping jaws 15 or the undersides thereof.

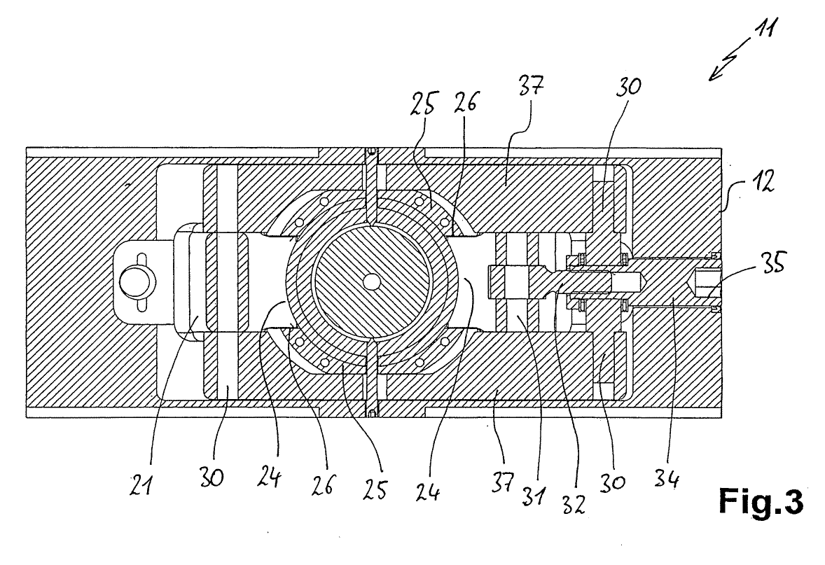

As can in particular be gathered from FIG. 3, the left-hand connection spindle 30 of the left-hand lever arm 21 is mounted in two thrust rods 37, which extend with a large mutual spacing close to the outer edge of the structure 12 in the longitudinal direction thereof. On their right-hand side the thrust rods 37 are also connected by means of a connection spindle 30. However, the latter is not mounted in or does not run through the right-hand lever arm 21 and instead carries a threaded bush 34 in such a way that it can be rotated, e.g. by the engagement of a tool on the hexagonal recess 35 about the horizontal axis illustrated by the dot-dash line. Due to its mounting on the right-hand connection spindle 30, it does not move with respect thereto along said rotation axis. With the connection spindles 30, the two thrust rods 37 form the aforementioned thrust linkage. It must also be borne in mind that the two thrust rods 37 or the overall thrust linkage have a large free middle area 38, in which runs the extension of clamping means 18, particularly coupling pipe 25. On a bolt 31 mounted in the lower area of the right-hand lever arm 21 and running parallel to the left-hand spindle axis 30, is mounted a type of screw with a corresponding lug 32 in connected to rotate manner relative to the aforementioned rotation axis of threaded bush 34.

### Function

For actuation both of the clamping jaws 15 and the clamping means 18, which are normally only used alternatively in each case, either the clamping jaws 15 are brought into a desired starting position on the clamping carriage 14 or an aforementioned clamping head or bush is inserted in said clamping means 18. Then, using a corresponding tool, on the hexagonal recess 35 rotation takes place about the rotation axis shown in dot-dash line manner, e.g. clockwise for a standard thread. As the threaded bush 34 is mounted by means of the right-hand connection spindle 30 on the thrust rods 37 and the screw 32 is mounted by means of bolt 31 on the right-hand lever arm 21, the right-hand connection spindle 30 and bolt 31 are moved towards one another. This brings about a counterclockwise tilting of the right-hand lever arm 21. As a result both the clamping carriage 14 with clamping jaw 15 is moved leftwards towards the centre and also by means of projection 24 and groove 26 the coupling pipe 25 is moved downwards. Simultaneously the right-hand connection spindle 30 is moved leftwards and transmits this movement via the thrust rods 37 to the left-hand connection spindle 30, which brings about a clockwise swiveling of the left-hand lever arm 21. This in turn results in a movement of the left-hand clamping jaw 15 and a movement downwards of the left-hand projection 24 in the same direction as the right-hand projection 24. Whilst as a result of the pure cooperation between the left lever arm 21 and right lever arm 21 by means of thrust rods 37 the spacing between the clamping jaws 15 or clamping faces 16 would remain the same, there could also be a joint movement thereof to the left or right. However, this is prevented by the coupling of projections 24 of lever arms 21 to one another by means of coupling pipe 25. This brings about a type of forced synchronization or equal movement. In this connection the coupling pipe 25 not only serves for actuation purposes with respect to the additional clamping means 18, but also for the forced predetermined movement of lever arms 21 and therefore the entire clamping mechanism 11. The main clamping force can be transmitted by means of the thrust rods 37 between lever arms 21 and to the coupling pipe 25, via projections 24, is only applied sufficient force to synchronize the movement. This synchronization simultaneously means that the coupling pipe 25 is simultaneously drawn downwards from both sides, which brings about a very good clamping action at the clamping means 18.

For the precise adjustment of the actuation, the lever arm spindles 22 of lever arms 21 can be slightly displaced in structure 12. This can e.g. take place in that in one area they are round and in the other eccentric, i.e. in a bearing on structure 12 are round and within the lever arm 21 eccentric or vice versa. Obviously variants of the aforementioned embodiment are possible. Thus, in place of actuation via screw 32, together with the threaded bush 34 mounted on the right-hand connection spindle 30, an actuation can e.g. take place pneumatically or hydraulically. Moreover, the shape of the lever arms 21 can vary or the clamping means 18 could be positioned at some other favourable location on the structure 12. However, an arrangement of the clamping means 18 between lever arms 21 and therefore also between clamping jaws 15 is considered to be particularly advantageous.

Thus, a main function of the coupling pipe 25 is the actuation on clamping means 18 and for this purpose said coupling pipe 25 is forced downwards by the projections 24 of lever arms 21. A further main function is the synchronization together of the movement of lever arms 21 and for this purpose the coupling pipe 25 is mounted in tilt-proof manner. A particularly stressed advantage of the invention is that both main functions can always be performed simultaneously, the first main function only being necessary when using clamping means 18.

1. A clamping mechanism in the manner of a vice with two clamping jaws movable towards one another, the clamping jaws being guided on a guide on a structure, wherein a clamping means is provided on said structure for clamping a head or collets with an axial actuation direction into the structure.

2. The clamping mechanism according to claim 1, wherein the clamping jaws are in each case uniformly movable from both sides towards a point between them on clamping.

3. The clamping mechanism according to claim 1, wherein the clamping means between the clamping jaws is provided with the same access direction as for clamping on the clamping jaws.

4. The clamping mechanism according to claim 1, wherein there is a single actuating device for movement of the clamping jaws.

5. The clamping mechanism according to claim 1, wherein the clamping jaws and the clamping means have the same drive or control for the simultaneous actuation.

6. The clamping mechanism according to claim 16, wherein the actuating device has a lever gear with an actuating mechanism for the clamping jaws and clamping means, an actuating mechanism being provided for each clamping jaw and wherein the actuating mechanisms are forcibly coupled by means of a coupling part.

7. The clamping mechanism according to claim 6, wherein the coupling part is part of the clamping means.

8. The clamping mechanism according to claim 6, wherein, on moving the clamping jaws towards one another, the coupling part is movable downwards into the structure and this is simultaneously the clamping direction of clamping means.

9. The clamping mechanism according to claim 6, wherein the two actuating mechanisms of the clamping jaws act externally and on opposite sides on coupling part.

10. The clamping mechanism according to claim 6, wherein the actuating mechanisms have or are lever arms, which at one end are connected to the actuating device and on a first, further end to in each case a clamping jaw and at a second, further end to the clamping means or a coupling part of said clamping means.

11. The clamping mechanism according to claim 10, wherein the lever arms of the actuating mechanisms have a bearing point between the connection to the actuating device and the connection to the clamping jaws.

12. The clamping mechanism according to claim 10, wherein a thrust linkage is provided, the actuating direction actuating by means of thrust linkage the two actuating mechanisms for the movement of the clamping jaws and for this purpose is connected thereto.

13. The clamping mechanism according to claim 12, wherein the thrust linkage runs in a plane through which passes the clamping means.

14. The clamping mechanism according to claim 13, wherein the clamping means traverses the free middle area.

15. The clamping mechanism according to claim 2, wherein the clamping jaws are movable towards the clamping means.

16. The clamping mechanism according to claim 4, wherein the actuating device for movement of the clamping jaws also controls the clamping means for simultaneous actuation with the clamping jaws.

17. The clamping mechanism according to claim 7, wherein the coupling part is a vent pipe for a multipart coupling head, which cooperates with the clamping means for clamping workpieces.

18. The clamping mechanism according to claim 9, wherein the two actuating mechanisms in each case engage with a projection in corresponding grooves on the coupling part, said engagement being of a positive nature along the coupling part movement direction.

19. The clamping mechanism according to claim 12, wherein a screw is mounted on an actuating mechanism and engages in a rotary nut on the closest thrust linkage and on turning the nut from the outside for actuation the nut and screw are tightened and by means of the thrust linkage the actuating mechanisms are moved.

20. The clamping mechanism according to claim 19, wherein the clamping means are also moved by means of the thrust linkage.

21. The clamping mechanism according to claim 13, wherein the thrust linkage has a large, free middle area and runs on both sides close to the outer edge of the structure.
